(19) United States
(12) Patent Application Publication
(10) Pub. No.: US 2019/0081376 A1
(43) Pub. Date: Mar. 14, 2019

(54) CONNECTOR FOR WAVEGUIDE, COMMUNICATION MODULE, TRANSMISSION CABLE, AND ELECTRONIC DEVICE

(71) Applicant: SONY CORPORATION, TOKYO (JP)

(72) Inventors: TAKAHIRO TAKEDA, KANAGAWA (JP); YASUHIRO OKADA, KANAGAWA (JP)

(21) Appl. No.: 16/093,747

(22) PCT Filed: Mar. 31, 2017
(86) PCT No.: PCT/JP2017/013509

§ 371 Date: Oct. 15, 2018

(30) Foreign Application Priority Data
Apr. 15, 2016 (JP) 2016-082088

(51) Int. Cl. H01P 1/04; H01P 3/14; H01P 5/02; H01P 3/12

(52) U.S. Cl. CPC H01P 1/042; H01P 3/122; H01P 5/02; H01P 3/14

(57) ABSTRACT

The present technology relates to a connector for a waveguide, a communication module, a transmission cable, and an electronic device capable of reducing sizes of devices and parts using a plurality of waveguides. A connector for a waveguide is provided with an insertion unit in which a plurality of waveguides is inserted in a state in which side surfaces are opposed to each other, and a plurality of waveguide paths which connects a mounting surface which is a surface mounted on a substrate and the insertion unit and transmits signals transmitted by corresponding waveguides. The present technology is applicable to electronic devices which transmit signals using a plurality of waveguides, for example.

### TECHNICAL FIELD

The present technology relates to a connector for a waveguide, a communication module, a transmission cable, and an electronic device, and especially relates to a connector for a waveguide, a communication module, a transmission cable, and an electronic device suitable for use in a case of transmitting signals by a plurality of waveguides.

### BACKGROUND ART

A signal transmission cable is conventionally proposed in which signals input or output through a connector unit in which waveguides are connected in parallel horizontally are vertically parallelized by a single layer multilayer conversion unit to transmit by a multilayer parallel waveguide in which a plurality of waveguides is stacked (for example, refer to Patent Document 1).

### CITATION LIST

### Patent Document

Patent Document 1: Japanese Patent Application Laid-Open No. 2014-212465

### SUMMARY OF THE INVENTION

### Problems to be Solved by the Invention

However, in the invention disclosed in Patent Document 1, since the waveguides are horizontally arranged in the connector unit, a width of the connector unit is widened. As a result, for example, sizes of devices and parts using the signal transmission cable increase.

Therefore, the present technology is to make it possible to reduce the sizes of the devices and parts using a plurality of waveguides.

### Solutions to Problems

A connector for a waveguide according to a first aspect of the present technology is provided with an insertion unit in which a plurality of waveguides is inserted in a state in which side surfaces are opposed to each other, and a plurality of waveguide paths which connects a mounting surface which is a surface mounted on a substrate and the insertion unit and transmits signals transmitted by corresponding waveguides.

The plurality of waveguides may be attached to and detached from the insertion unit, and a fixing member which directly or indirectly applies force in a direction in which the side surfaces of the waveguides oppose to each other to fix a waveguide to the insertion unit may be further provided.

Ends of opposed surfaces of adjacent waveguides are joined to opposite surfaces of a conductive plate, so that the plurality of waveguides may be bundled, and the fixing member may push a side surface of the waveguide of at least one of the waveguides arranged on outermost sides in the direction in which the side surfaces of the waveguides oppose to each other and include a first fixing member having conductivity.

The conductive plate may be wider than a surface joined to the conductive plate of the waveguide, the insertion unit may be provided with a slot for inserting the conductive plate, and the fixing member may include a second fixing member having conductivity which pushes the conductive plate in the direction in which the side surfaces of the waveguides oppose to each other in the slot.

The conductive plate may protrude from a tip end of the waveguide, and a conductive rubber in a position where the tip end of the conductive plate abuts when the plurality of waveguides is inserted in the insertion unit may be further provided.

The insertion unit may be formed on a surface perpendicular to the mounting surface, and the plurality of the waveguides may be inserted in the insertion unit so as to be arranged in a direction perpendicular to the mounting surface.

A mounting surface side of the insertion unit may be opened, and a side surface of the waveguide inserted in a position the closest to the mounting surface may come into contact with the substrate via the opening of the insertion unit.

Openings on the mounting surface side of the plurality of waveguide paths may be arranged in an insertion direction of the waveguide.

A cross-section of the waveguide is substantially rectangular, and the plurality of waveguides may be inserted in the insertion unit in a state in which wider side surfaces of the waveguides are arranged so as to be opposed to each other.

A communication module according to a second aspect of the present technology is provided with a substrate, and a first connector for a waveguide mounted on a first surface of the substrate, in which the first connector for a waveguide is provided with a first insertion unit in which a plurality of waveguides is inserted in a state in which side surfaces are opposed to each other, and a plurality of first waveguide paths which connects a first mounting surface which is a surface mounted on the first surface of the substrate to the first insertion unit and transmits signals transmitted by corresponding waveguides.

The substrate may be provided with a plurality of second waveguide paths connected to the first waveguide paths, respectively, and at least partial sections of the second waveguide paths may be stacked in the substrate.

A plurality of chips each of which performs at least either transmission or reception of a signal through each of the waveguides is further provided, in which the second waveguide paths may connect to corresponding chips and the first waveguide paths, respectively.

The first insertion unit may be formed on a surface perpendicular to the mounting surface, and the chips may be arranged on the substrate in at least one of an insertion direction of the waveguides in the first insertion unit or a direction perpendicular to the insertion direction.

The chips may be mounted on both sides of the substrate.

Each of the second waveguide paths may include a conductor layer formed on a surface and inside of the substrate and a via connecting adjacent conductor layers.

A second connector for a waveguide mounted on a second surface on a side opposite to the first surface of the substrate is further provided, in which the second connector for a waveguide is provided with a second insertion unit in which the plurality of waveguides is inserted in a state in which side surfaces are opposed to each other, and a plurality of third waveguide paths which connects a second mounting surface which is a surface mounted on the substrate to the second insertion unit and transmits signals transmitted by corresponding waveguides, the substrate is provided with a plurality of fourth waveguide paths which connects to the third waveguide paths, and at least partial sections of the second waveguide paths and the fourth waveguide paths may be stacked in the substrate.

A plurality of waveguides may be further provided.

A transmission cable according to a third aspect of the present technology is provided with a plurality of waveguides, and a plurality of conductive plates, in which side surfaces of the waveguides are arranged so as to be opposed to each other, and ends of opposing surfaces of adjacent waveguides are joined to opposite surfaces of a conductive plate, so that the plurality of waveguides is bundled.

The conductive plate may be wider than a surface of a waveguide joined to the conductive plate, and the conductive plate may protrude from a tip end of the waveguide.

An electronic device according to a fourth aspect of the present technology is provided with a communication module provided with a substrate, and a connector for a waveguide mounted on the substrate, and

a signal processing unit which processes a signal transmitted through the communication module, in which the connector for a waveguide is provided with an insertion unit in which a plurality of waveguides is inserted in a state in which side surfaces are opposed to each other, and a plurality of waveguide paths which connects a mounting surface which is a surface mounted on the substrate to the insertion unit and transmits signals transmitted by corresponding waveguides.

In the first aspect of the present technology, a plurality of waveguides inserted in the connector for a waveguide in a state in which the side surfaces are opposed to each other is connected to the substrate via the waveguide path of the connector for a waveguide.

In the second aspect of the present technology, a plurality of waveguides inserted in a first connector for a waveguide in a state in which the side surfaces are opposed to each other is connected to the substrate via a first waveguide path of the first connector for a waveguide.

In a third aspect of the present technology, a plurality of waveguides is bundled in a state in which the side surfaces are opposed to each other.

In the fourth aspect of the present technology, a plurality of waveguides inserted in the connector for a waveguide in a state in which the side surfaces are opposed to each other is connected to the substrate via the waveguide path of the connector for a waveguide.

### Effects of the Invention

According to the first aspect to the fourth aspect of the present technology, it is possible to reduce a width of the connector for a waveguide. As a result, it is possible to reduce the size of devices and parts using a plurality of waveguides.

Note that the effects described herein are not necessarily limited and may be any of the effects described in the present disclosure.

### BRIEF DESCRIPTION OF DRAWINGS

FIG. 1 is a block diagram illustrating an embodiment of a communication system to which the present technology is applied.

FIG. 2 is a schematic diagram of a communication module in a state in which a transmission cable is connected as seen from above in a first embodiment of the present technology.

FIG. 3 is a schematic diagram of the communication module in the state in which the transmission cable is connected as seen from the side in the first embodiment of the present technology.

FIG. 4 is a perspective view of a connector in FIG. 2 as seen from diagonally below.

FIG. 5 is a perspective view of the connector in FIG. 2 as seen from diagonally above.

FIG. 6 is a view of the connector in FIG. 2 as seen from a lower surface side.

FIG. 7 is a view of the connector in FIG. 2 as seen from a rear surface side.

FIG. 8 is a perspective view of the vicinity of an end of the transmission cable in FIG. 2.

FIG. 9 is a plan view of the vicinity of the end of the transmission cable in FIG. 2.

FIG. 10 is a left side view of the vicinity of the end of the transmission cable in FIG. 2.

FIG. 11 is a front view of the vicinity of the end of the transmission cable in FIG. 2.

FIG. 12 is a schematic diagram of a positional relationship between each unit of the connector in FIG. 2 and the transmission cable.

FIG. 13 is a schematic diagram of a state in which the transmission cable is inserted in the connector in FIG. 2 as seen from a rear side of the connector.

FIG. 14 schematically illustrates the vicinity of an upper left portion of the transmission cable in the state in which the transmission cable is inserted in the connector in FIG. 2.

FIG. 15 is a view for illustrating a flow of a signal between the communication module and the transmission cable in FIG. 2.

FIG. 16 is a schematic diagram of a communication module in a state in which a transmission cable is connected as seen from above in a second embodiment of the present technology.

FIG. 17 is a schematic diagram of the communication module in the state in which the transmission cable is connected as seen from the side in the second embodiment of the present technology.

FIG. 18 is a view for illustrating a flow of a signal between the communication module and the transmission cable in FIG. 16.

FIG. 19 is a schematic diagram of a communication module in a state in which a transmission cable is connected as seen from above in a third embodiment of the present technology.

FIG. 20 is a schematic diagram of the communication module in the state in which the transmission cable is connected as seen from the side in the third embodiment of the present technology.

FIG. 21 is a view for illustrating a flow of a signal between the communication module and the transmission cable in FIG. 19.

FIG. 22 is a schematic diagram of a communication module in a state in which a transmission cable is connected as seen from above in a fourth embodiment of the present technology.

FIG. 23 is a schematic diagram of the communication module in the state in which the transmission cable is connected as seen from the side in the fourth embodiment of the present technology.

FIG. 24 is a view for illustrating a flow of a signal between the communication module and the transmission cable in FIG. 22.

### MODE FOR CARRYING OUT THE INVENTION

Hereinafter, a mode for carrying out the invention (hereinafter referred to as an “embodiment”) is described in detail with reference to the drawings. Note that the description is given in the following order.

1. First Embodiment

2. Second Embodiment (Example in which chips are arranged perpendicularly to insertion direction of transmission cable)

3. Third Embodiment (Example in which connector for transmission cable is provided on both sides of substrate)

4. Fourth Embodiment (Example in which waveguide is individually inserted in connector)

5. Variation

### 1. First Embodiment

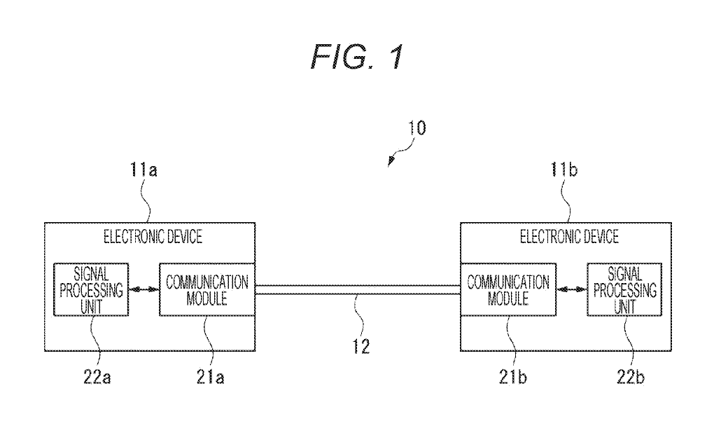

A first embodiment of the present technology is first described with reference to FIGS. 1 to 15.

FIG. 1 is a block diagram illustrating a configuration example of an embodiment of a communication system 10 to which the present technology is applied.

The communication system 10 is provided with an electronic device 11a, an electronic device 11b, and a transmission cable 12. The electronic device 11a and the electronic device 11b are connected to each other via the transmission cable 12.

The electronic device 11a and the electronic device 11b may communicate using high-frequency electromagnetic waves having a frequency range of 30 to 300 GHz (hereinafter referred to as millimeter waves). The electronic device 11a and the electronic device 11b are provided with a communication module 21a and a communication module 21b having similar configurations, respectively, and may perform high-speed signal transmission of Gbps order (for example, 5 Gbps or higher) by performing communication using electromagnetic waves in a millimeter wave band.

Furthermore, the electronic device 11a and the electronic device 11b are provided with a signal processing unit 22a and a signal processing unit 22b, respectively. The signal processing unit 22a and the signal processing unit 22b process signals and the like transmitted between the electronic device 11a and the electronic device 11b.

Note that the electronic device 11a and the electronic device 11b may be independent products or parts in the independent products, for example.

Note that, hereinafter, in a case where it is not necessary to distinguish between the communication module 21a and the communication module 21b, they are simply referred to as communication modules 21.

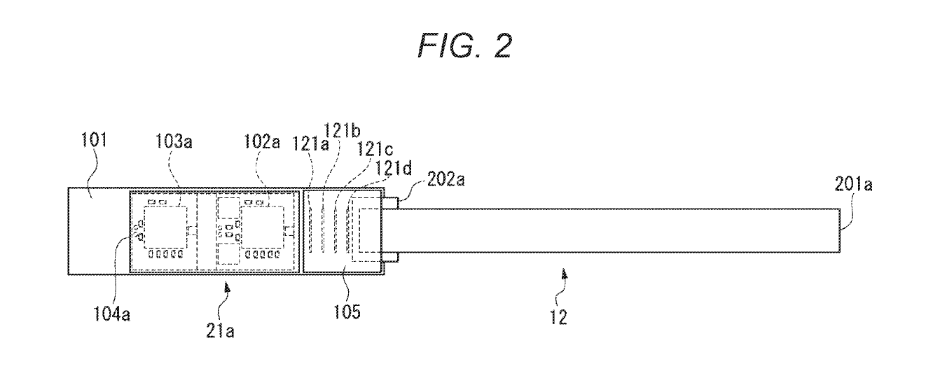

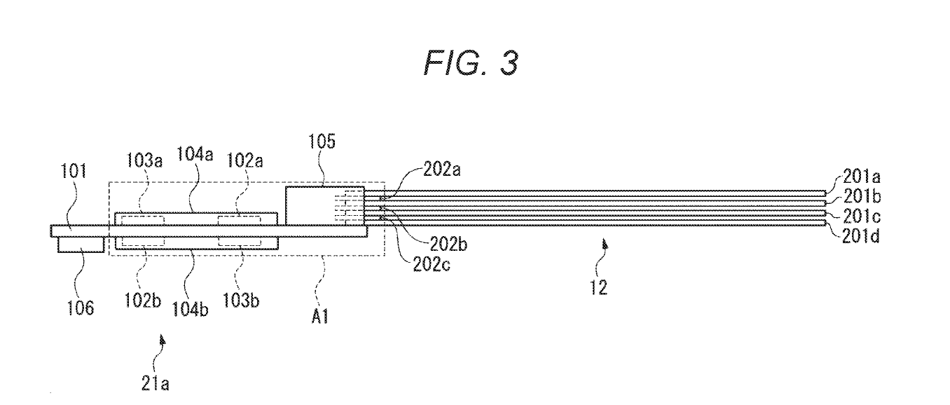

FIGS. 2 and 3 schematically illustrate the communication module 21a in a state in which the transmission cable 12 is connected thereto. FIG. 2 is a schematic diagram of the communication module 21a as seen from above, and FIG. 3 is a schematic diagram of the communication module 21a as seen from the side.

Note that, hereinafter, a direction in which the transmission cable 12 is inserted of the communication module 21a is set as a front-rear direction with a side to which the transmission cable 12 is connected being set as a rear side and the opposite side thereof being set as a front side. Furthermore, hereinafter, a direction perpendicular to a surface of a substrate 101 of the communication module 21a is set as a vertical direction with a side illustrated in FIG. 2 being set as an upper side and the opposite side thereof being set as a lower side. Moreover, hereinafter, a direction perpendicular to the above-described front-rear direction and vertical direction is set as a right-to-left direction of the communication module 21a with a side illustrated in FIG. 3 being set as a left side and the opposite side thereof being set as a right side.

The communication module 21a is provided with the substrate 101, a transmission chip 102a, a transmission chip 102b, a reception chip 103a, a reception chip 103b, a shield 104a, a shield 104b, a connector 105, and a connector 106.

The substrate 101 is a substrate including a dielectric and includes resin such as flame retardant type 4 (FR4), for example.

On an upper surface of the substrate 101, the reception chip 103a, the transmission chip 102a, and the connector 105 are mounted so as to be arranged in the front-rear direction from a position away from a front end of the substrate 101 by a predetermined distance. On a lower surface of the substrate 101, the connector 106, the transmission chip 102b, and the reception chip 103b are mounted so as to be arranged in the front-rear direction from the vicinity of a substantially front end of the substrate 101. The reception chip 103a and the transmission chip 102b are mounted in substantially the same position with the substrate 101 interposed therebetween, and the transmission chip 102a and the reception chip 103b are mounted in substantially the same position with the substrate 101 interposed therebetween. Furthermore, in a position where the connector 105 is mounted on the upper surface of the substrate 101, slots 121a to 121d extending to right and left are formed so as to be arranged in the front-rear direction.

The transmission chip 102a up-converts a baseband signal supplied from the signal processing unit 22a of the electronic device 11a via the connector 106 and the substrate 101 to a millimeter wave band signal (hereinafter referred to as a millimeter wave signal). Furthermore, the transmission chip 102a transmits the obtained millimeter wave signal to the electronic device 11b via the substrate 101, the connector 105, and a waveguide 201a of the transmission cable 12.

The transmission chip 102b up-converts the baseband signal supplied from the signal processing unit 22a of the electronic device 11a via the connector 106 and the substrate 101 to a millimeter wave signal. Furthermore, the transmission chip 102b transmits the obtained millimeter wave signal to the electronic device 11b via the substrate 101, the connector 105, and a waveguide 201c of the transmission cable 12.

The reception chip 103a receives a millimeter wave signal transmitted from the electronic device 11b via the waveguide 201b of the transmission cable 12, the connector 105, and the substrate 101. Furthermore, the reception chip 103a down-converts the received millimeter wave signal to a baseband signal and supplies the obtained baseband signal to the signal processing unit 22a of the electronic device 11a via the substrate 101 and the connector 106.

The reception chip 103b receives a millimeter wave signal transmitted from the electronic device 11b via a waveguide 201d of the transmission cable 12, the connector 105, and the substrate 101. Furthermore, the reception chip 103b down-converts the received millimeter wave signal to a baseband signal and supplies the obtained baseband signal to the signal processing unit 22a of the electronic device 11a via the substrate 101 and the connector 106.

Note that, for example, the transmission chip 102a and the transmission chip 102b transmit different signals. Furthermore, for example, the reception chip 103a and the reception chip 103b receive different signals.

The shield 104a covers peripheries of the transmission chip 102a and the reception chip 103a and separates the transmission chip 102a from the reception chip 103a. The shield 104b covers peripheries of the transmission chip 102b and the reception chip 103b and separates the transmission chip 102b from the reception chip 103b.

The connector 105 is a connector for connecting the transmission cable 12 capable of attaching and detaching the transmission cable 12.

The connector 106 is a connector for connecting the communication module 21a to a motherboard and the like of the electronic device 11a.

Note that the communication module 21b of the electronic device 11b has a configuration similar to that of the communication module 21a and the description thereof is not repeated.

The transmission cable 12 is provided with the waveguides 201a to 201d and conductive plates 202a to 202c.

Each of the waveguides 201a to 201d is such that a tubular conductive layer having a substantially rectangular cross-section is filled with a dielectric. Metal is used as the conductive layer, for example. Insulating resin such as LCP, liquid crystal polymer, Teflon (registered trademark), and ceramic is used, for example, as the dielectric. Furthermore, the waveguides 201a to 201d are flexible and may be easily bent.

Note that the conductive layer of each of the waveguides 201a to 201d may have a hollow interior.

The conductive plates 202a to 202c are rectangular plates including a conductor such as metal.

As is to be described in detail later, the waveguides 201a to 201d are arranged in a longitudinal direction such that wider side surfaces are opposed via the conductive plates 202a to 202c.

Note that an electronic device 11b side of the transmission cable 12 also has a configuration similar to that of the electronic device 11a side, and the description thereof is not repeated.

Furthermore, hereinafter, in a case where it is not necessary to distinguish the waveguides 201a to 201d from one another, they are simply referred to as waveguides 201, and in a case where it is not necessary to distinguish the conductive plates 202a to 202c from one another, they are simply referred to as conductive plates 202.

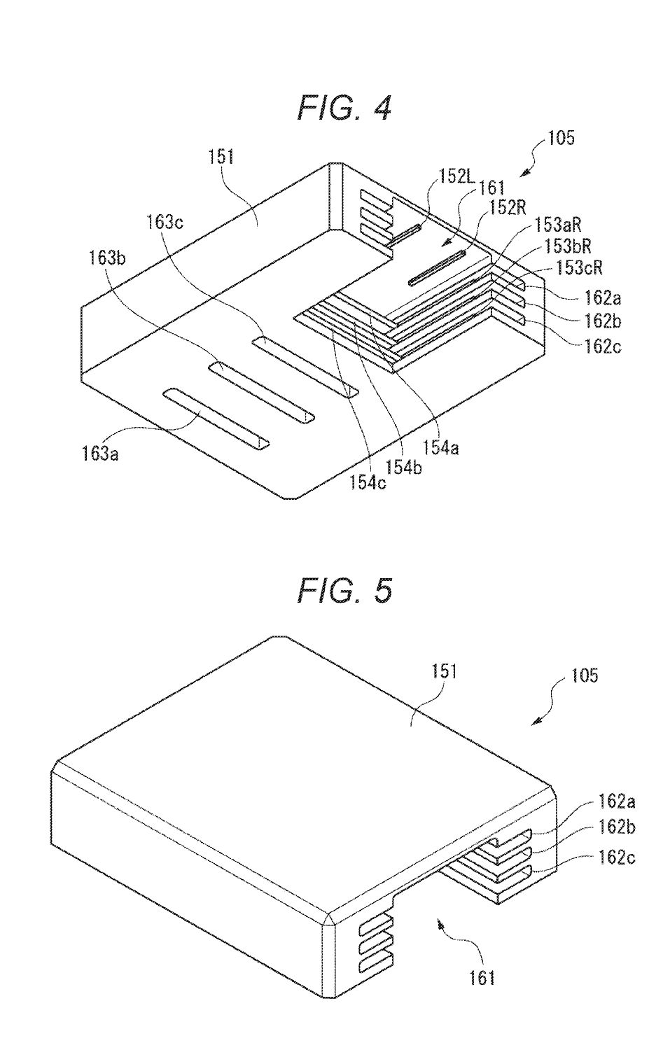

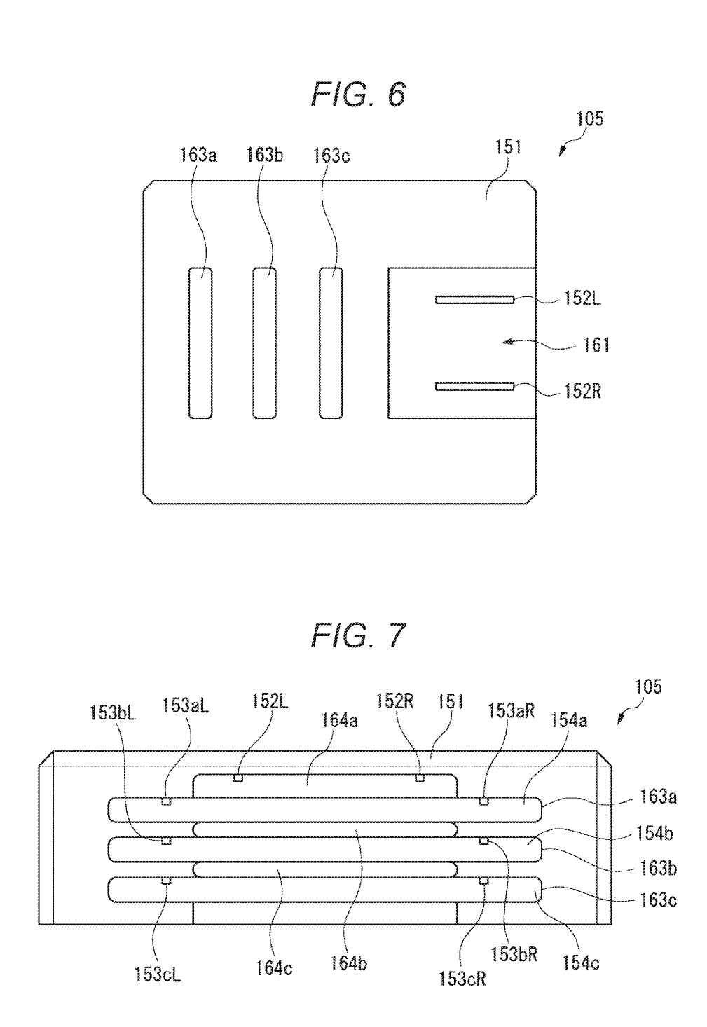

Next, the connector 105 is described in detail with reference to FIGS. 4 to 7. FIG. 4 is a perspective view of the connector 105 as seen from diagonally below, and FIG. 5 is a perspective view of the connector 105 as seen from diagonally above. FIG. 6 is a view of the connector 105 as seen from a lower surface (mounting surface mounted on the substrate 101) side, and FIG. 7 is a view of the connector 105 as seen from a rear surface (insertion surface in which the transmission cable 12 is inserted) side.

The connector 105 is provided with a main body portion 151, a conductor spring 152L, a conductor spring 152R, conductor springs 153aL to 153cR, and conductive rubbers 154a to 154c. The conductor spring 152L, the conductor spring 152R, the conductor springs 153aL to 153cR, and the conductive rubbers 154a to 154c have conductivity, respectively.

The main body portion 151 includes a substantially rectangular parallelepiped member having a conductive surface (for example, a metallic member, a member plated with metal on a plastic surface and the like). An opening 161 is formed on a rear surface and a lower surface of the main body portion 151. The opening 161 is slightly wider in the right-to-left direction than the waveguide 201 and is slightly higher than a thickness in a vertical direction of the transmission cable 12 (stacking direction of the waveguides 201).

Furthermore, slots 162a to 162c are formed on the rear surface of the main body portion 151 so as to be vertically arranged at predetermined intervals. The slots 162a to 162c are slightly wider and thicker than the conductive plates 202a to 202c of the transmission cable 12 and further extend to right and left from the opening 161.

The opening 161 and the slots 162a to 162c form an insertion unit for inserting the transmission cable 12.

On a ceiling of the opening 161, the conductor spring 152L and the conductor spring 152R are provided. The conductor spring 152L and the conductor spring 152R extend in the front-rear direction and are arranged right and left at predetermined intervals.

Furthermore, on a ceiling of the slot 162a, the conductor spring 153aL and the conductor spring 153aR are provided. Specifically, the conductor spring 153aL is provided on the ceiling of a groove on a left side of the slot 162a so as to extend in the front-rear direction. The conductor spring 153aR is provided on the ceiling of a groove on a right side of the slot 162a in a position substantially symmetrical with the conductor spring 153aL.

Moreover, the conductor spring 153bL and the conductor spring 153bR are provided on a ceiling of the slot 162b in positions overlapping with the conductor spring 153aL and the conductor spring 153aR in the vertical direction, respectively. Furthermore, the conductor spring 153cL and the conductor spring 153cR are provided on a ceiling of the slot 162c in positions overlapping with the conductor spring 153aL and the conductor spring 153aR in the vertical direction, respectively.

Furthermore, the conductive rubbers 154a to 154c are joined to the back of the slots 162a to 162c, respectively, by a conductive adhesive. Each of the conductive rubbers 154a to 154c has a plate shape extending to right and left and has conductivity.

Moreover, waveguide paths 163a to 163c are formed on the main body portion 151. Each of the waveguide paths 163a to 163c has a shape obtained by folding a rectangular hole a cross-section of which is elongated to right and left into an L shape and connects the insertion unit and the lower surface of the main body portion 151.

Note that the lower surface of the main body portion 151 of the connector 105 which is the surface to be mounted on the substrate 101 is hereinafter also referred to as a mounting surface. Note that a surface on which each member (for example, the connector 105 and the like) is mounted of the substrate 101 is also hereinafter referred to as a mounting surface.

The waveguide path 163a is a waveguide path for the waveguide 201a. One opening of the waveguide path 163a has a rectangular shape slightly larger than a cross-section of the waveguide 201a and is formed above the slot 162a at the back of the opening 161. The other opening of the waveguide path 163a is formed in a position corresponding to the slot 121a of the substrate 101 on the lower surface of the main body portion 151.

The waveguide path 163b is a waveguide path for the waveguide 201b. One opening of the waveguide path 163b has a rectangular shape slightly larger than a cross-section of the waveguide 201b and is formed between the slot 162a and the slot 162b at the back of the opening 161. The other opening of the waveguide path 163b is formed in a position corresponding to the slot 121b of the substrate 101 on the lower surface of the main body portion 151.

The waveguide path 163c is a waveguide path for the waveguide 201c. One opening of the waveguide path 163c has a rectangular shape slightly larger than a cross-section of the waveguide 201c and is formed between the slot 162b and the slot 162c at the back of the opening 161. The other opening of the waveguide path 163c is formed in a position corresponding to the slot 121c of the substrate 101 on the lower surface of the main body portion 151.

Accordingly, the openings on the rear surface side of the waveguide paths 163a to 163c are arranged vertically at predetermined intervals. The openings on the lower surface side of the waveguide paths 163a to 163c are arranged in the front-rear direction (insertion direction of the transmission cable 12).

Note that the waveguide path for the waveguide 201d includes a part of the opening 161.

Furthermore, characteristic impedance is adjusted so as to ensure consistency among the waveguide paths by adjusting dimensions or filling with a dielectric having a specific dielectric constant, for example, as for the waveguide paths 163a to 163c and the waveguide path for the waveguide 201d.

Note that, hereinafter, in a case where it is not necessary to distinguish between the conductor spring 152L and the conductor spring 152R, they are simply referred to as conductor springs 152. Furthermore, hereinafter, in a case where it is not necessary to distinguish the conductor springs 153aL to 153cR from one another, they are simply referred to as conductor springs 153.

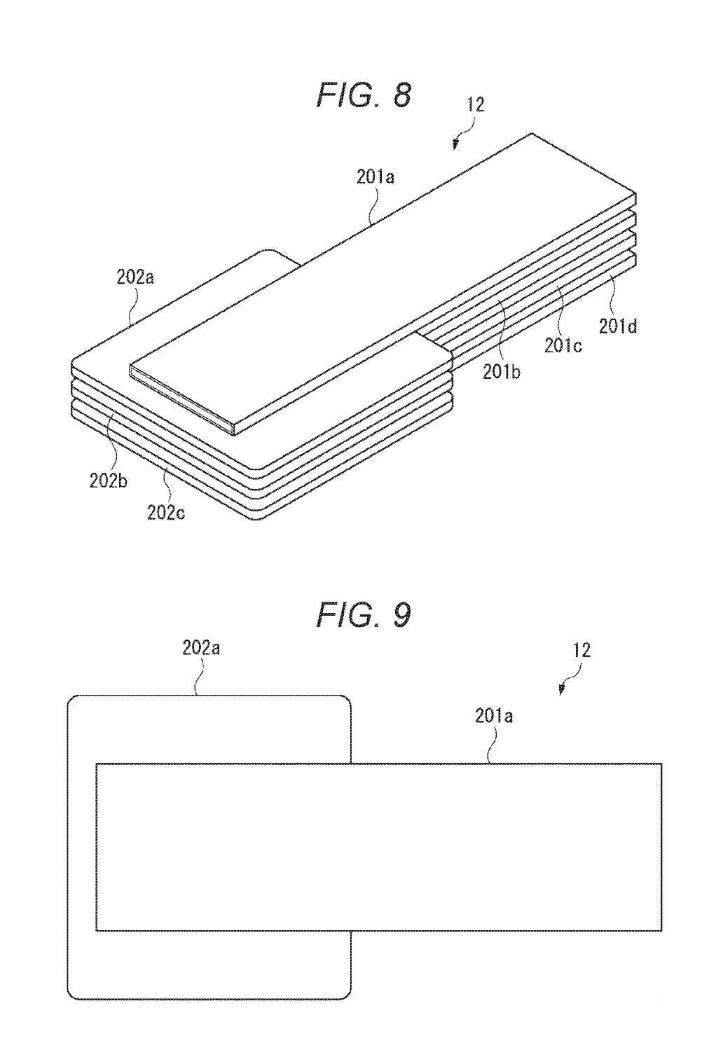

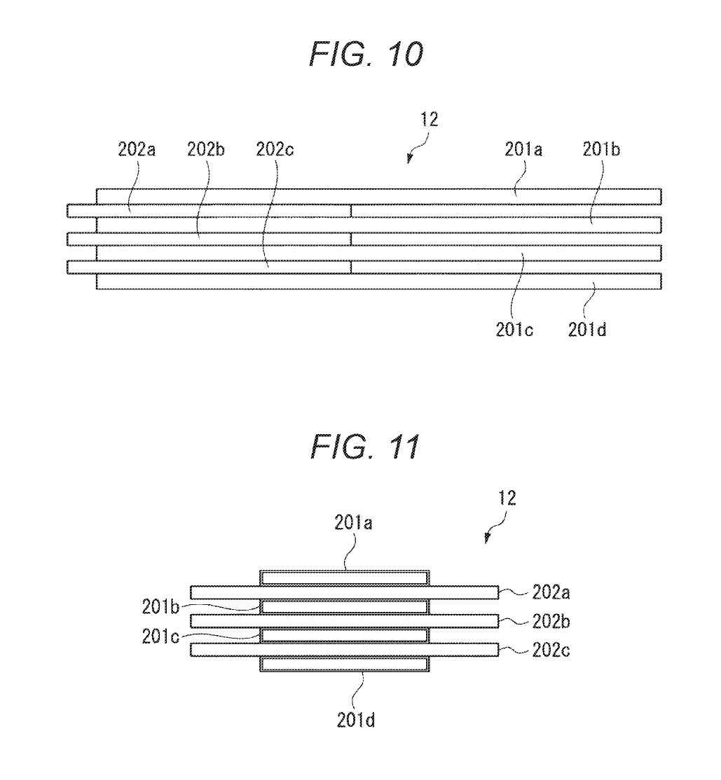

Next, the transmission cable 12 is described in detail with reference to FIGS. 8 to 11. FIG. 8 is a perspective view of the vicinity of an end on the electronic device 11a side of the transmission cable 12, FIG. 9 is a plan view of the vicinity of the end on the electronic device 11a side of the transmission cable 12, FIG. 10 is a left side view of the vicinity of the end on the electronic device 11a side of the transmission cable 12, and FIG. 11 is a front view of the vicinity of the end on the electronic device 11a side of the transmission cable 12.

In the transmission cable 12, the waveguides 201a to 201d are arranged (stacked) in the longitudinal direction such that the wider side surfaces are opposed with the ends aligned. The conductive plate 202a is inserted between the waveguide 201a and the waveguide 201b and the opposing surfaces of the waveguide 201a and the waveguide 201b are joined to the opposite side surfaces of the conductive plate 202a by a conductive adhesive. The conductive plate 202b is inserted between the waveguide 201b and the waveguide 201c and the opposing surfaces of the waveguide 201b and the waveguide 201c are joined to the opposite side surfaces of the conductive plate 202b by a conductive adhesive. The conductive plate 202c is inserted between the waveguide 201c and the waveguide 201d and the opposing surfaces of the waveguide 201c and the waveguide 201d are joined to the opposite side surfaces of the conductive plate 202c by a conductive adhesive.

Furthermore, the conductive plate 202 is wider than the surface joined to the conductive plate 202 of the waveguide 201 and a tip end of the conductive plate 202 protrudes from a tip end of the waveguide 201.

Note that an electronic device 11b side of the transmission cable 12 also has a configuration similar to that of the electronic device 11a side, and the description thereof is not repeated.

In this manner, the ends of a plurality of waveguides 201 are bundled by the conductive plate 202 to form a harness.

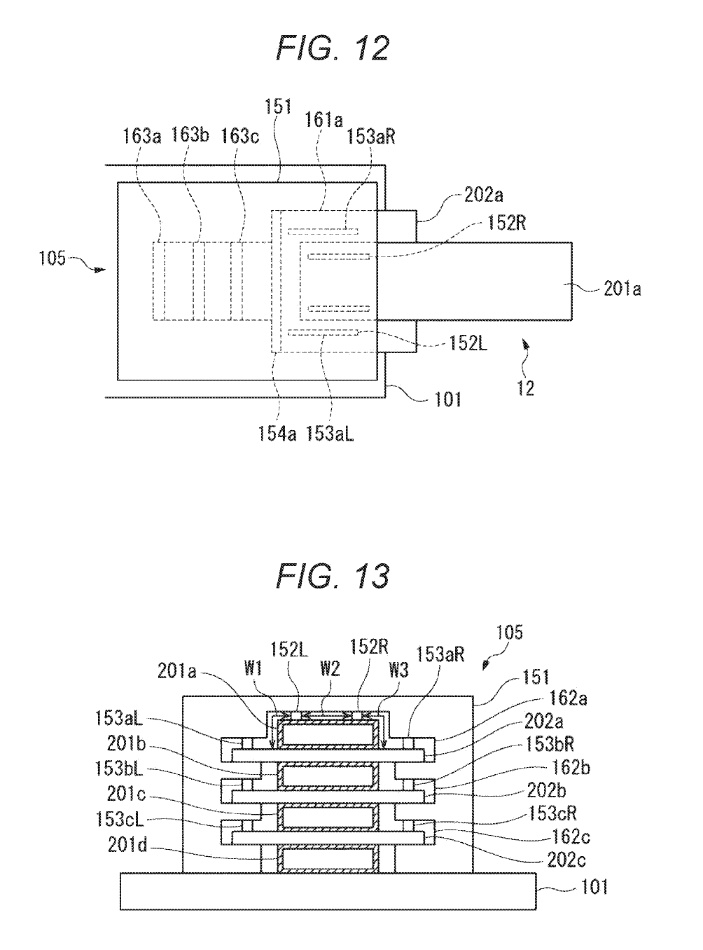

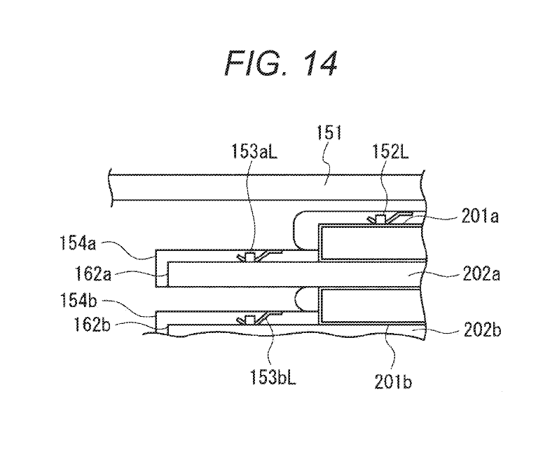

FIGS. 12 to 14 illustrate a state in which the transmission cable 12 is inserted in the connector 105. Specifically, FIG. 12 schematically illustrates a positional relationship between each unit of the connector 105 and the transmission cable 12. FIG. 13 is a schematic diagram of the state in which the transmission cable 12 is inserted in the connector 105 as seen from the rear side (insertion surface side) of the connector 105. FIG. 14 schematically illustrates the vicinity of an upper left portion of the transmission cable 12 in the state in which the transmission cable 12 is inserted in the connector 105.

When the transmission cable 12 is inserted in the insertion unit (the opening 161 and the slots 162a to 162c) of the connector 105, the conductive plates 202a to 202c are inserted in the slots 162a to 162c, respectively. Furthermore, the tip ends of the conductive plates 202a to 202c abut the conductive rubbers 154a to 154c at the back of the slots 162a to 162c to be brought into close contact with them, respectively. As a result, it becomes possible to block a gap between each conductive plate 202 and the connector 105, thereby suppressing electromagnetic wave leakage. Furthermore, the waveguides 202 are arranged in a direction substantially perpendicular to the mounting surface of the substrate 101 (the mounting surface of the main body portion 151 of the connector 105) (vertical direction).

Then, an upper surface of the waveguide 201a arranged on the outermost side of the transmission cable 12 is pressed downward (in a direction in which the side surfaces of the waveguides 201 oppose) by the conductor spring 152L and the conductor spring 152R on the ceiling of the opening 161.

Furthermore, the conductive plate 202a is pressed downward (in a direction in which the side surfaces of the waveguides 201 oppose) by the conductor spring 153aL and the conductor spring 153aR on the ceiling of the slot 162a. As a result, a lower surface of the conductive plate 202a is brought into close contact with a floor surface of the slot 162a. Similarly, the conductive plate 202b is pressed downward by the conductor spring 153bL and the conductor spring 153bR on the ceiling of the slot 162b, and a lower surface of the conductive plate 202b is brought into close contact with a floor surface of the slot 162b. The conductive plate 202c is pressed downward by the conductor spring 153cL and the conductor spring 153cR on the ceiling of the slot 162c, and a lower surface of the conductive plate 202c is brought into close contact with a floor surface of the slot 162c.

In this manner, when the transmission cable 12 is inserted in the connector 105, the transmission cable 12 is entirely pressed downward by the conductor springs 152 and the conductor springs 153, and each waveguide 201 is directly or indirectly pressed downward. As a result, the transmission cable 12 is fixed to the insertion unit of the connector 105 and a position of each waveguide 201 is fixed. Furthermore, a lower surface of the waveguide 201d inserted in a position the closest to the lower surface (mounting surface) of the connector 105 comes into contact with the upper surface of the substrate 101 via an opening on a lower surface of the opening 161 and is brought into close contact with the same.

Here, as illustrated in FIG. 13, in the state in which the transmission cable 12 is inserted in the connector 105, a gap is formed between the waveguide 201a and the main body portion 151 of the connector 105. This gap is divided into three parts by the conductor spring 152L and the conductor spring 152R. Of this gap, a width from the conductor spring 152L to the conductive plate 202a is set to W1, a width between the conductor spring 152L and the conductor spring 152R is set to W2, and a width from the conductor spring 152R to the conductive plate 202a is set to W3. Furthermore, the longest width among the widths W1 to W3 is set to Wmax.

Then, a cutoff frequency fc of a basic mode (TE10) of the waveguide 201a is obtained by following equation (1) on the basis of the width Wmax, a dielectric constant ε_{γ}, and a light speed c.

$$\begin{matrix}[ Equation 1 ] & \\ fc = \frac{c}{2 W max \sqrt{{ɛ}_{r}}} & ( 1 )\end{matrix}$$

Therefore, the shorter the width Wmax, the higher the cutoff frequency fc, and a lower-frequency signal becomes less likely to leak from the gap.

Note that the width Wmax is desirably designed to be ½ or shorter of a wavelength of the millimeter wave signal transmitted by the waveguide 201a. Furthermore, a thickness of a gap between the waveguide 201a and the main body portion 151 of the connector 105 (distance between the waveguide 201a and the main body portion 151) is desirably designed to be ½ or shorter of the width Wmax. Moreover, a length in a transmission direction of the millimeter wave signal (front-rear direction) of the conductor spring 152 is desirably designed to be ½ or longer of the wavelength of the millimeter wave signal transmitted by the waveguide 201a. Furthermore, a thickness of the conductor spring 152 is preferably larger than a thickness of a conductor layer of the waveguide 201a.

Since a gap between each of the waveguides 201b to 201d and the main body portion 151 of the connector 105 is narrower than the gap between the waveguide 201a and the main body portion 151, if the gap between the waveguide 201a and the main body portion 151 satisfies the above-described condition, too much consideration is not required. Note that the length in the transmission direction of the millimeter wave signal (front-rear direction) of each conductor spring 153 is desirably designed to be ½ or longer of the wavelength of the millimeter wave signal transmitted by each waveguide 201.

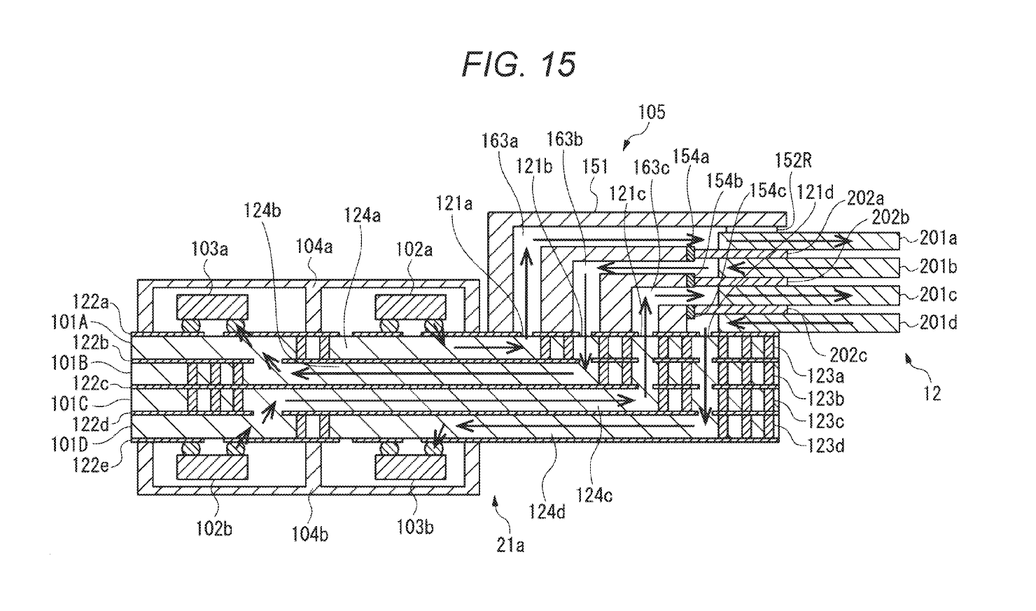

Next, a flow of a signal between the communication module 21a and the transmission cable 12 is described with reference to FIG. 15. FIG. 15 schematically illustrates a cross-section of a portion enclosed by dotted line frame A1 in FIG. 3.

On the upper and lower surfaces of the substrate 101, a conductor layer 122a and a conductor layer 122e are formed. Furthermore, conductor layers 122b to 122d are formed inside the substrate 101, and the substrate 101 is divided into first to fourth layers 101A to 101D by the conductor layers 122b to 122d. Each of the conductor layers 122a to 122e is of a copper foil, for example.

Furthermore, openings are provided on the conductor layer 122a in positions corresponding to the openings of the waveguide paths 163a to 163c of the connector 105, and the openings form the slots 121a to 121c. Moreover, in the vicinity of the back of the opening 161 of the connector 105, an opening is provided on the conductor layer 122a, and this opening forms the slot 121d.

Furthermore, the conductor layer 122a and the conductor layer 122b are connected to each other by means of a plurality of vias 123a. The conductor layer 122b and the conductor layer 122c are connected to each other by a plurality of vias 123b. The conductor layer 122c and the conductor layer 122d are connected to each other by a plurality of vias 123c. The conductor layer 122d and the conductor layer 122e are connected to each other by a plurality of vias 123d.

Then, an area enclosed by the conductor layers 122a and 122b and the vias 123a forms a waveguide path 124a. The waveguide path 124a connects the slot 121a to the transmission chip 102a in the first layer 101A of the substrate 101. The millimeter wave signal output from the transmission chip 102a is inserted in the waveguide 201a via the waveguide path 124a of the substrate 101 and the waveguide path 163a of the connector 105.

Furthermore, an area enclosed by the conductor layers 122b and 122c and the vias 123a and 123b forms a waveguide path 124b. The waveguide path 124b penetrates the first layer 101A of the substrate 101 and connects the slot 121b to the reception chip 103a in the second layer 101B. The millimeter wave signal transmitted by the waveguide 201b is supplied to the reception chip 103a via the waveguide path 163b of the connector 105 and the waveguide path 124b of the substrate 101.

Moreover, an area enclosed by the conductor layers 122c and 122d and the vias 123a to 123c forms a waveguide path 124c. The waveguide path 124c penetrates the first layer 101A and the second layer 101B of the substrate 101 and connects the slot 121c to the transmission chip 102b in the third layer 101C. The millimeter wave signal output from the transmission chip 102b is inserted in the waveguide 201c via the waveguide path 124c of the substrate 101 and the waveguide path 163c of the connector 105.

Furthermore, an area enclosed by the conductor layers 122d and 122e and the vias 123a to 123d forms a waveguide path 124d. The waveguide path 124d penetrates the first layer 101A to the third layer 101C of the substrate 101 and connects the slot 121d to the reception chip 103b in the fourth layer 101D. The millimeter wave signal transmitted by the waveguide 201d is supplied to the reception chip 103b via the waveguide path including a part of the opening 161 of the main body portion 151 of the connector 105 and the waveguide path 124d of the substrate 101.

As described above, by arranging the waveguides 201a to 201d in the longitudinal direction, it is possible to reduce widths of the connector 105 and the communication module 21a. More specifically, the widths of the connector 105 and the communication module 21 may be made substantially the same as the width of the transmission cable 12. As a result, it is possible to reduce the size of devices and parts using a plurality of waveguides.

Furthermore, by arranging the transmission chip 102a and the reception chip 103a and the transmission chip 102b and the reception chip 103b on both sides of the substrate 101, it becomes possible to reduce an area of the communication module (substrate 101).

Moreover, in the technology disclosed in Patent Document 1 described above, the connector unit and the waveguide are integrated. Therefore, for example, it is necessary to manufacture all of the connector unit and the waveguide by a process of a flexible printed circuit board, and the number that may be manufactured from one panel is reduced, so that a cost might be high. Furthermore, even if a defect or failure occurs in one of the connector unit and the waveguide, it is difficult to repair only one of them, and it is necessary to replace all of them.

In contrast, in the communication system 10, the transmission cable 12 may be attached to and detached from the connector 105 of the communication module 21, and the transmission cable 12 and the connector 105 (communication module 21) may be manufactured by an optimal process, so that it is possible to reduce the cost. Furthermore, when a defect or failure occurs in one of the transmission cable 12 and the connector 105, it is possible to repair or exchange only one of them, so that a required cost may be reduced.

Moreover, it is possible to reduce a portion in which the waveguide paths 124a to 124d are separated by the vias 123a to 123d by stacking partial sections of the waveguide paths 124a to 124d in the vertical direction within the substrate 101. As a result, interference of the signals among the waveguide paths 124a to 124d may be suppressed, and isolation of the signals transmitted by the respective waveguide paths may be improved.

Furthermore, since the transmission chip 102a and the reception chip 103a are separated from each other by the shield 104a, interference of the signals between the chips may be suppressed, and isolation of the signals may be improved Similarly, since the transmission chip 102b and the reception chip 103b are separated from each other by the shield 104b, interference of the signals between the chips may be suppressed, and isolation of the signals may be improved

Moreover, the electromagnetic wave leakage from the gap is suppressed by making the gap between the transmission cable 12 and the connector 105 smaller by the conductor spring 152, the conductor spring 153, and the conductive rubbers 154a to 154c, so that occurrence of unnecessary radiation, cross talk and the like is suppressed.

### 2. Second Embodiment

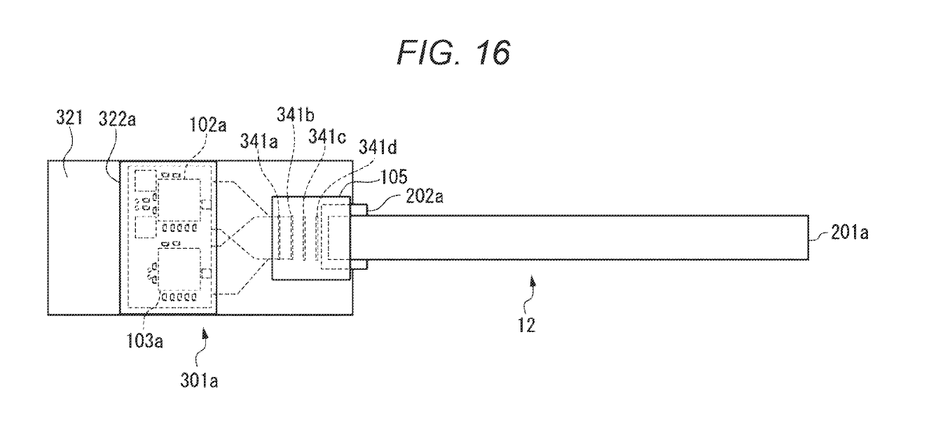

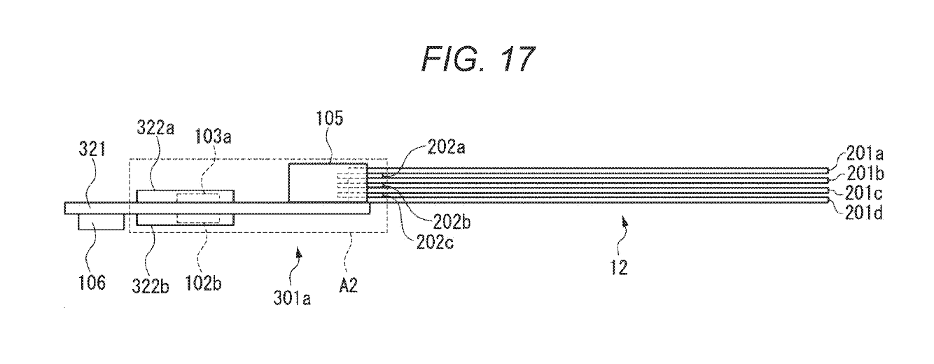

Next, a second embodiment of the present technology is described with reference to FIGS. 16 to 18.

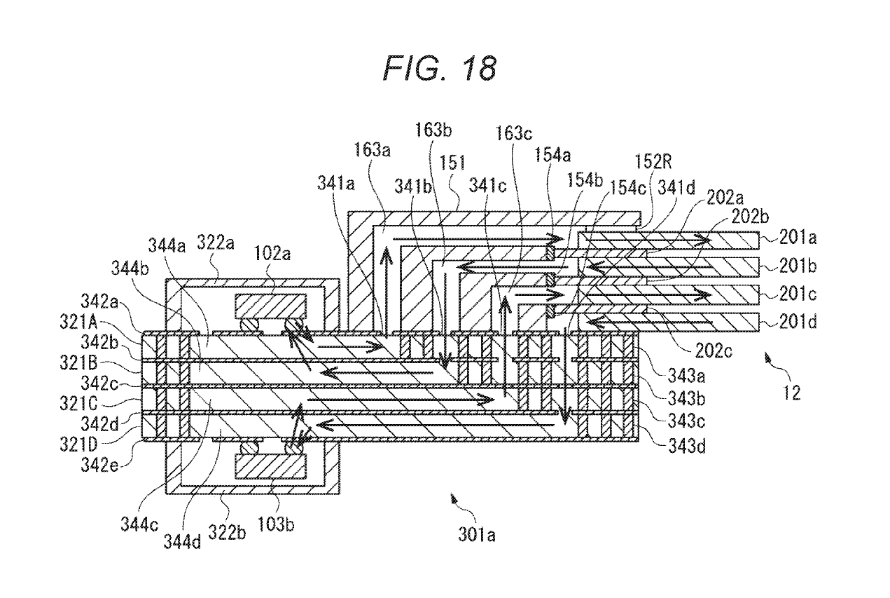

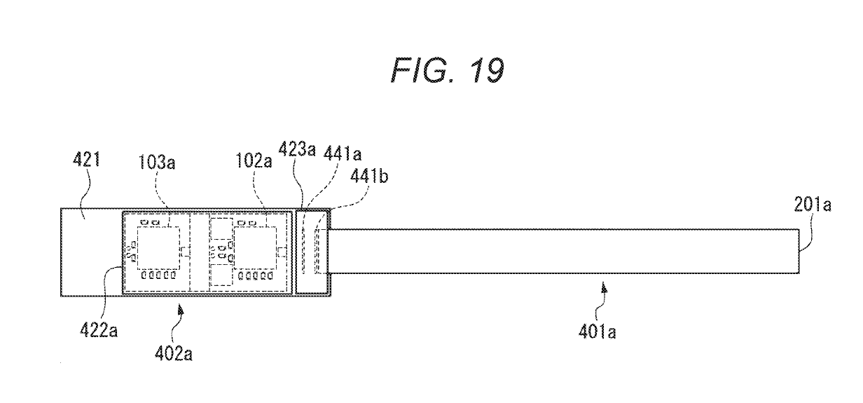

FIGS. 16 and 17 schematically illustrate a communication module 301a in a state in which a transmission cable 12 is connected thereto. FIG. 16 is a schematic diagram of the communication module 301a as seen from above, and FIG. 17 is a schematic diagram of the communication module 301a as seen from the side. Note that, in the drawings, the parts corresponding to those in FIGS. 2 and 3 are assigned with the same reference signs. FIG. 18 schematically illustrates a cross-section of a portion enclosed by dotted line frame A2 in FIG. 17. Note that, in the drawings, the parts corresponding to those in FIG. 15 are assigned with the same reference signs.

The second embodiment of the present technology differs from the first embodiment in that the communication module 301a and a communication module 301b (not illustrated) are provided in place of communication modules 21a and 21b.

The communication module 301a differs from the communication module 21a in that a substrate 321 and shields 322a and 322b are provided in place of a substrate 101 and shields 104a and 104b. Furthermore, the communication module 301a differs from the communication module 21a in that a transmission chip 102a and a reception chip 103a, and a transmission chip 102b and a reception chip 103b are arranged right and left.

Specifically, on an upper surface of the substrate 321, the reception chip 103a and the transmission chip 102a are mounted so as to be arranged right and left in a position away from a front end of the substrate 101 by a predetermined distance. Furthermore, on the upper surface of the substrate 321, a connector 105 is mounted behind the transmission chip 102a and the reception chip 103a, in a position away from the transmission chip 102a and the reception chip 103a by a predetermined distance.

A connector 106 is mounted on a substantially front end of a lower surface of the substrate 321. Furthermore, behind the connector 106, the transmission chip 102b and the reception chip 103b (FIG. 18) are arranged right and left. The reception chip 103a and the transmission chip 102b are mounted in substantially the same position with the substrate 101 interposed therebetween, and the transmission chip 102a and the reception chip 103b are mounted in substantially the same position with the substrate 101 interposed therebetween.

Furthermore, in a position where the connector 105 is mounted on the upper surface of the substrate 321, slots 341a to 341d extending to right and left are formed to be arranged in a front-rear direction.

The shield 322a covers peripheries of the transmission chip 102a and the reception chip 103a and separates the transmission chip 102a from the reception chip 103a. The shield 322b covers peripheries of the transmission chip 102b and the reception chip 103b and separates the transmission chip 102b from the reception chip 103b.

As illustrated in FIG. 18, a conductor layer 342a and a conductor layer 342e are formed on the upper surface and the lower surface of the substrate 321. Furthermore, conductor layers 342b to 342d are also formed in the substrate 321, and the substrate 321 is divided into first to fourth layers 321A to 321D by the conductor layers 342b to 342d.

Furthermore, openings are provided on the conductor layer 342a in positions corresponding to openings of waveguide paths 163a to 163c of the connector 105, and the openings form the slots 341a to 341c. Moreover, in the vicinity of the back of the opening 161 of the connector 105, an opening is provided on the conductor layer 342a, and this opening forms the slot 341d.

Furthermore, the conductor layer 342a and the conductor layer 342b are connected to each other by means of a plurality of vias 343a. The conductor layer 342b and the conductor layer 342c are connected to each other by a plurality of vias 343b. The conductor layer 342c and the conductor layer 342d are connected to each other by a plurality of vias 343c. The conductor layer 342d and the conductor layer 342e are connected to each other by a plurality of vias 343d.

Then, an area enclosed by the conductor layers 342a and 342b and the vias 343a forms a waveguide path 344a. The waveguide path 344a connects the slot 341a to the transmission chip 102a in the first layer 321A of the substrate 321. A millimeter wave signal output from the transmission chip 102a is inserted in a waveguide 201a via the waveguide path 344a of the substrate 321 and the waveguide path 163a of the connector 105.

Furthermore, an area enclosed by the conductor layers 342b and 342c and the vias 343a and 343b forms a waveguide path 344b. The waveguide path 344b penetrates the first layer 321A of the substrate 321 and connects the slot 341b to the reception chip 103a in the second layer 321B. The millimeter wave signal transmitted by a waveguide 201b is supplied to the reception chip 103a via the waveguide path 163b of the connector 105 and the waveguide path 344b of the substrate 321.

Moreover, an area enclosed by the conductor layers 342c and 342d and the vias 343a to 343c forms a waveguide path 344c. The waveguide path 344c penetrates the first layer 321A and the second layer 321B of the substrate 321 and connects the slot 341c to the transmission chip 102 in the third layer 321C. The millimeter wave signal output from the transmission chip 102b is inserted in a waveguide 201c via the waveguide path 344c of the substrate 321 and the waveguide path 163c of the connector 105.

Furthermore, an area enclosed by the conductor layers 342d and 342e and the vias 343a to 343d forms a waveguide path 344d. The waveguide path 344d penetrates the first layer 321A to the third layer 321C of the substrate 321 and connects the slot 341d to the reception chip 103b in the fourth layer 321D. The millimeter wave signal transmitted by the waveguide 201d is supplied to the reception chip 103b via the waveguide path including a part of the opening 161 of the main body portion 151 of the connector 105 and the waveguide path 344d of the substrate 321.

Note that the communication module 301b has a configuration similar to that of the communication module 301a and the description thereof is not repeated.

As described above, it is also possible to arrange the chips in a direction perpendicular to an insertion direction of the transmission cable 12.

### 3. Third Embodiment

Next, a third embodiment of the present technology is described with reference to FIGS. 19 to 21.

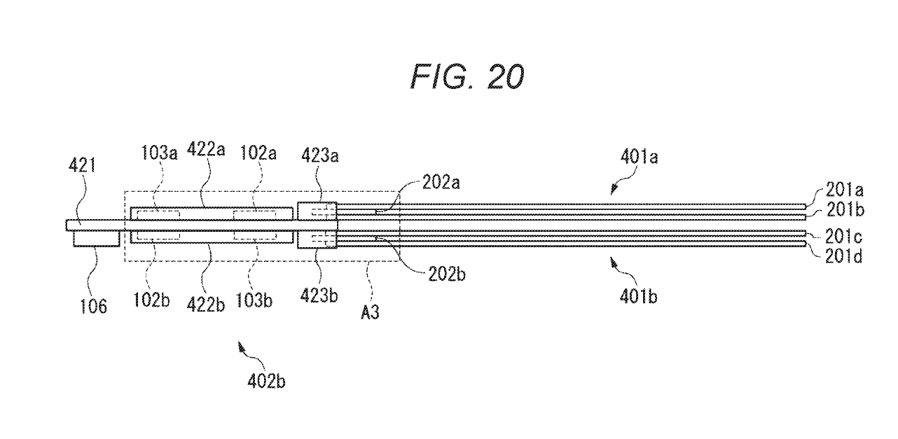

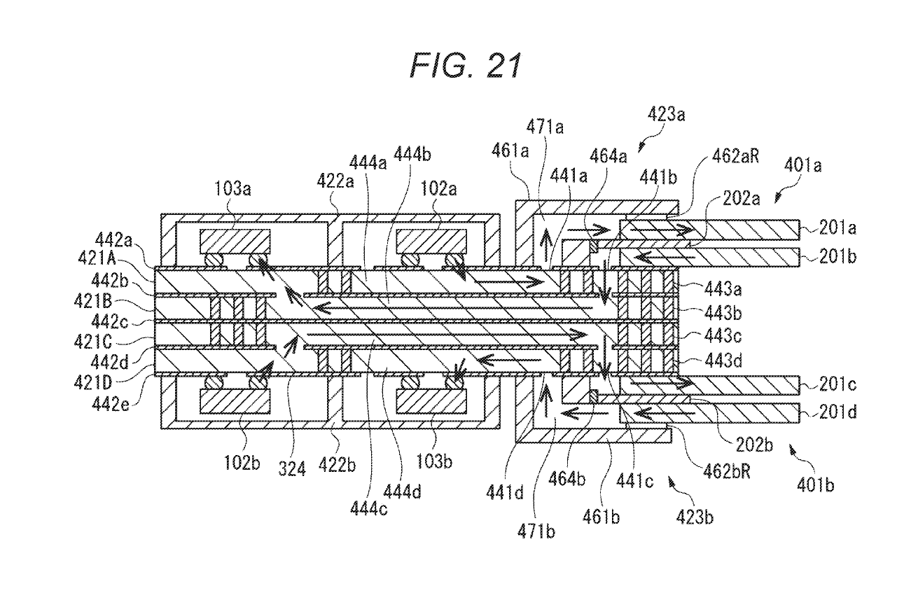

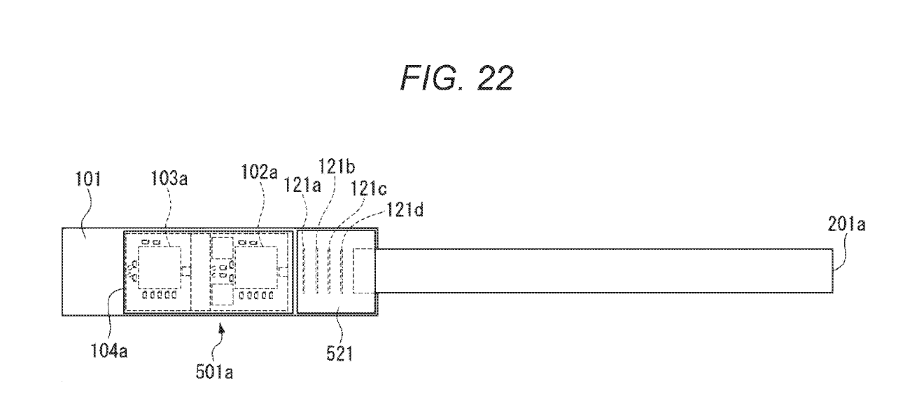

FIGS. 19 and 20 schematically illustrate a communication module 402a in a state in which transmission cables 401a and 401b are connected thereto. FIG. 19 is a schematic diagram of the communication module 402a as seen from above, and FIG. 20 is a schematic diagram of the communication module 402a as seen from the side. Note that, in the drawings, the parts corresponding to those in FIGS. 2 and 3 are assigned with the same reference signs. FIG. 21 schematically illustrates a cross-section of a portion enclosed by dotted line frame A3 in FIG. 20. Note that, in the drawings, the parts corresponding to those in FIG. 15 are assigned with the same reference signs.

The third embodiment of the present technology differs from the first embodiment in that the transmission cables 401a and 401b are provided in place of a transmission cable 12, and the communication module 402a and a communication module 402b (not illustrated) are provided in place of communication modules 21a and 21b.

In the transmission cables 401a and 401b, the number of stacked waveguides is different from that in the transmission cable 12. In other words, the stacked number in the transmission cable 12 is four, but the stacked number in the transmission cables 401a and 401b is two.

In the transmission cable 401a, a conductive plate 202a is inserted between a waveguide 201a and a waveguide 201b, and the waveguides 201a and 201b and the conductive plate 202a are joined by a conductive adhesive.

In the transmission cable 401b, a conductive plate 202b is inserted between a waveguide 201c and a waveguide 201d, and the waveguides 201c and 201d and the conductive plate 202b are joined by a conductive adhesive.

The communication module 402a differs from the communication module 21a in that a substrate 421 is provided in place of a substrate 101 and a connector 423a and a connector 423b are provided in place of a connector 105. The communication module 402a greatly differs from the communication module 21a in that the connector 423a and the connector 423b are mounted on both sides of the substrate 421.

On an upper surface of the substrate 421, a reception chip 103a, a transmission chip 102a, and the connector 423a are mounted so as to be arranged in a front-rear direction from a position away from a front end of the substrate 101 by a predetermined distance. On a lower surface of the substrate 101, a connector 106, a transmission chip 102b, a reception chip 103b, and the connector 423b are mounted so as to be arranged in the front-rear direction from the vicinity of a substantially front end of the substrate 101. The reception chip 103a and the transmission chip 102b are mounted in substantially the same position with the substrate 421 interposed therebetween, and the transmission chip 102a and the reception chip 103b are mounted in substantially the same position with the substrate 421 interposed therebetween. Furthermore, the connector 423a and the connector 423b are mounted in substantially the same position with the substrate 421 interposed therebetween.

Furthermore, in a position where the connector 423a is mounted on the upper surface of the substrate 421, a slot 441a and a slot 441b extending to right and left are formed to be arranged in the front-rear direction. Furthermore, a slot 441d and a slot 441c are formed in positions corresponding to the slots 441a and 441b on the lower surface of the substrate 421, respectively.

The connector 423a is different from the connector 105 in FIGS. 4 to 7 in the number of slots and waveguide paths. In other words, the numbers of the waveguides and the conductive plates of the transmission cable 401a attached to and detached from the connector 423a are smaller than the numbers of the waveguides and the conductive plates of the transmission cable 12 inserted in the connector 105. Therefore, in a main body portion 461a of the connector 423a, the number of slots is reduced from three to one and the number of L-shaped waveguide paths is reduced from three to one as compared with the main body portion 151 of the connector 105. Therefore, the connector 423a becomes smaller than the connector 105 in height, and becomes shorter in a depth direction (front-rear direction).

Note that, in the connector 423a also, a conductor spring 462aL (not illustrated) and a conductor spring 462aR similar to a conductor spring 152L and a conductor spring 152R of the connector 105 are provided in positions similar to those of the conductor spring 152L and the conductor spring 152R. Furthermore, a conductor spring 463aL (not illustrated) and a conductor spring 463aR (not illustrated) similar to a conductor spring 153aL and a conductor spring 153aR of the connector 105 are provided in positions similar to those of the conductor spring 153aL and the conductor spring 153aR. Moreover, a conductive rubber 464a (FIG. 21) similar to a conductive rubber 154c of the connector 105 is provided in a position similar to that of the conductive rubber 154c.

The connector 423b has a configuration similar to that of the connector 423a, and the description thereof is not repeated.

As illustrated in FIG. 21, a conductor layer 442a and a conductor layer 442e are formed on the upper surface and the lower surface of the substrate 421. Furthermore, conductor layers 442b to 442d are formed inside the substrate 421, and the substrate 421 is divided into first to fourth layers 421A to 421D by the conductor layers 442b to 442d.

Furthermore, an opening is provided on the conductor layer 442a in a position corresponding to an opening of a waveguide path 471a of the connector 423a, and the opening forms the slot 441a. Moreover, in the vicinity of the back of the opening of the connector 423a, an opening is provided on the conductor layer 442a, and this opening forms the slot 441b.

Furthermore, an opening is provided on the conductor layer 442e in a position corresponding to an opening of a waveguide path 471b of the connector 423b, and the opening forms the slot 441d. Moreover, in the vicinity of the back of the opening of the connector 423b, an opening is provided on the conductor layer 442e, and this opening forms the slot 441c.

Furthermore, the conductor layer 442a and the conductor layer 442b are connected to each other by means of a plurality of vias 443a. The conductor layer 442b and the conductor layer 442c are connected to each other by a plurality of vias 443b. The conductor layer 442c and the conductor layer 442d are connected to each other by a plurality of vias 443c. The conductor layer 442d and the conductor layer 442e are connected to each other by a plurality of vias 443d.

Then, an area enclosed by the conductor layers 442a and 442b and the vias 443a forms a waveguide path 444a. The waveguide path 444a connects the slot 441a to the transmission chip 102a in the first layer 421A of the substrate 421. A millimeter wave signal output from the transmission chip 102a is inserted in the waveguide 201a via the waveguide path 444a of the substrate 421 and the waveguide path 471a of the connector 423a.

Furthermore, an area enclosed by the conductor layers 442b and 442c and the vias 443a and 443b forms a waveguide path 444b. The waveguide path 444b penetrates the first layer 421A of the substrate 421 and connects the slot 441b to the reception chip 103a in the second layer 421B. The millimeter wave signal transmitted by the waveguide 201b is supplied to the reception chip 103a via the waveguide path including a part of the opening of the main body portion 461a of the connector 423a and the waveguide path 444b of the substrate 421.

Moreover, an area enclosed by the conductor layers 442c and 442d and the vias 443c and 443d forms the waveguide path 444c. The waveguide path 444c penetrates the fourth layer 421D of the substrate 421 and connects the slot 441c to the transmission chip 102b in the third layer 421C. The millimeter wave signal output from the transmission chip 102b is inserted in the waveguide 201c via the waveguide path 444c of the substrate 421 and the waveguide path including a part of the opening of the main body portion 461b of the connector 423b.

Furthermore, an area enclosed by the conductor layers 442d and 442e and the vias 443d forms a waveguide path 444d. The waveguide path 444d connects the slot 441d to the reception chip 103b in the fourth layer 421D of the substrate 421. The millimeter wave signal transmitted by the waveguide 201d is supplied to the reception chip 103a via the waveguide path 471b of the connector 423b and the waveguide path 444d of the substrate 421.

Note that characteristic impedance is adjusted so as to ensure consistency among the waveguide paths by adjusting dimensions or filling with a dielectric having a specific dielectric constant, for example, as for the waveguide path 471a of the connector 423a and the waveguide path for the waveguide 201b, and the waveguide path 471b of the connector 423b and the waveguide path for the waveguide 201c.

Note that the communication module 402b has a configuration similar to that of the communication module 402a and the description thereof is not repeated.

As described above, it is also possible to divide the transmission cable into two, and provide a connector for the transmission cable on both sides of the substrate of the communication module.

### 4. Fourth Embodiment

Next, a fourth embodiment of the present technology is described with reference to FIGS. 22 to 24.

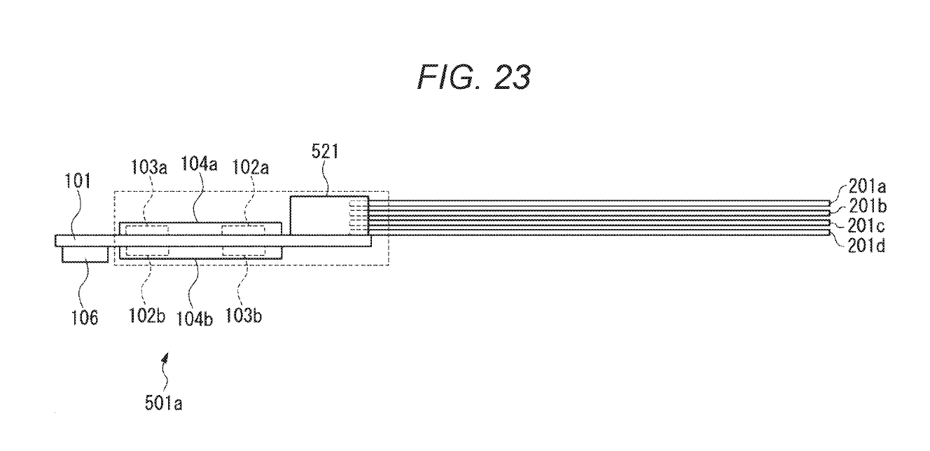

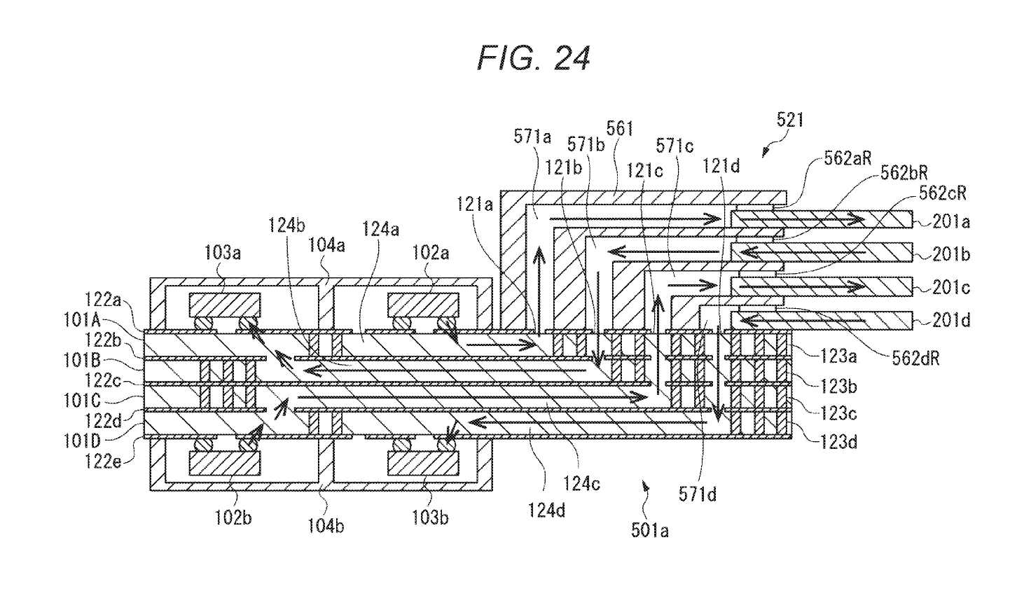

FIGS. 22 and 23 schematically illustrate a communication module 501a in a state in which waveguides 201a to 201d are connected to the communication module 501a. FIG. 22 is a schematic diagram of the communication module 501a as seen from above, and FIG. 23 is a schematic diagram of the communication module 501a as seen from the side. Note that, in the drawings, the parts corresponding to those in FIGS. 2 and 3 are assigned with the same reference signs. FIG. 24 schematically illustrates a cross-section of a portion enclosed by dotted line frame A4 in FIG. 23. Note that, in the drawings, the parts corresponding to those in FIG. 15 are assigned with the same reference signs.

The fourth embodiment of the present technology is different from the first embodiment in that the communication module 501a and a communication module 501b (not illustrated) are provided in place of a communication module 21a and a communication module 21b, respectively, and the waveguides 201a to 201d are attached to and detached from the communication module 501a and the communication module 501b one by one without forming a harness.

The communication module 501a is different from the communication module 21a in that a connector 521 is provided in place of a connector 105. Furthermore, the difference is that the waveguides 201 do not form a harness, and each waveguide 201 is inserted in the connector 521 separately.

As illustrated in FIG. 24, waveguide paths 571a to 571d are formed on a main body portion 561 of the connector 521.

Each of the waveguide paths 571a to 571c has a shape obtained by folding a rectangular hole a cross-section of which is elongated to right and left into an L shape like waveguide paths 163a to 163c of the connector 105.

The waveguide path 571a also serves as an insertion unit of the waveguide 201a, and is a waveguide path to and from which the waveguide 201a is attached and detached. One opening of the waveguide path 571a has a rectangular shape slightly larger than a cross-section of the waveguide 201a and is formed on a rear surface (insertion surface in which the waveguide 201a is inserted) of the main body portion 561 of the connector 521. The other opening of the waveguide path 571a is formed in a position corresponding to a slot 121a of a substrate 101 on a lower surface of the main body portion 561.

Furthermore, in the waveguide path 571a, a conductor spring 562aL (not illustrated) and a conductor spring 562aR similar to a conductor spring 152L and a conductor spring 152R are provided in positions substantially similar to those of the conductor spring 152L and the conductor spring 152R in the waveguide path 163a. The waveguide 201a is pressed downward (in a direction in which side surfaces of the waveguides 201 oppose) by the conductor spring 562aL and the conductor spring 562aR and is brought into close contact with a floor surface of the waveguide path 571a. As a result, a gap between the waveguide 201a and the floor surface of the waveguide path 571a is blocked and the waveguide 201a is fixed in the waveguide path 571a.

The waveguide path 571b also serves as an insertion unit of the waveguide 201b, and is a waveguide path to and from which the waveguide 201b is attached and detached. One opening of the waveguide path 571b has substantially the same shape as the opening on the rear surface side of the waveguide path 571a, and is formed on the rear surface (the insertion surface in which the waveguide 201b is inserted) of the main body portion 561 of the connector 521 in a position away from the opening of the waveguide path 571a downward by a predetermined distance. The other opening of the waveguide path 571b is formed in a position corresponding to a slot 121b of the substrate 101 on the lower surface of the main body portion 561.

Furthermore, in the waveguide path 571b, a conductor spring 562bL (not illustrated) and a conductor spring 562bR similar to the conductor spring 562aL and the conductor spring 562aR are provided in positions substantially overlapping with those of the conductor spring 562aL and the conductor spring 562aR in a vertical direction. The waveguide 201b is pressed downward (in a direction in which the side surfaces of the waveguides 201 oppose) by the conductor spring 562bL and the conductor spring 562bR and is brought into close contact with a floor surface of the waveguide path 571b. As a result, a gap between the waveguide 201b and the floor surface of the waveguide path 571b is blocked and the waveguide 201b is fixed in the waveguide path 571b.

The waveguide path 571c also serves as an insertion unit of the waveguide 201c and is a waveguide path to and from which the waveguide 201c is attached and detached. One opening of the waveguide path 571c has substantially the same shape as the opening on the rear surface side of the waveguide path 571a, and is formed on the rear surface (the insertion surface in which the waveguide 201c is inserted) of the main body portion 561 of the connector 521 in a position away from the opening of the waveguide path 571b downward by a predetermined distance. The other opening of the waveguide path 571c is formed in a position corresponding to a slot 121c of the substrate 101 on the lower surface of the main body portion 561.

Furthermore, in the waveguide path 571c, a conductor spring 562cL (not illustrated) and a conductor spring 562cR similar to the conductor spring 562aL and the conductor spring 562aR are provided in positions substantially overlapping with those of the conductor spring 562aL and the conductor spring 562aR in the vertical direction. The waveguide 201c is pressed downward (in a direction in which the side surfaces of the waveguides 201 oppose) by the conductor spring 562cL and the conductor spring 562cR and is brought into close contact with a floor surface of the waveguide path 571c. As a result, a gap between the waveguide 201c and the floor surface of the waveguide path 571c is blocked and the waveguide 201c is fixed in the waveguide path 571c.

The waveguide path 571d also serves as an insertion unit of the waveguide 201d and is a waveguide path to and from which the waveguide 201d is attached and detached. The waveguide path 571d is formed on the rear surface and a lower surface of the main body portion 561 of the connector 521. The opening on the rear surface side of the waveguide path 571d has substantially the same shape as the opening on the rear surface side of the waveguide path 571a.

Furthermore, in the waveguide path 571d, a conductor spring 562dL (not illustrated) and a conductor spring 562dR similar to the conductor spring 562aL and the conductor spring 562aR are provided in positions substantially overlapping with those of the conductor spring 562aL and the conductor spring 562aR in the vertical direction. The waveguide 201d is pressed downward (in a direction in which the side surfaces of the waveguides 201 oppose) by the conductor spring 562dL and the conductor spring 562dR and is brought into close contact with a mounting surface of the substrate 101. As a result, a gap between the waveguide 201d and the mounting surface of the substrate 101 is blocked and the waveguide 201d is fixed in the waveguide path 571d.

Note that conditions such as the installation positions, thicknesses, and lengths of the conductor springs 562aL to 562dR are similar to those of the conductor spring 152L and the conductor spring 152R of the connector 105 described above with reference to FIG. 13.

Then, as illustrated in FIG. 24, a millimeter wave signal output from a transmission chip 102a is inserted in the waveguide 201a via a waveguide path 124a of the substrate 101 and the waveguide path 571a of the connector 521.

The millimeter wave signal transmitted by the waveguide 201b is supplied to a reception chip 103a via the waveguide path 571b of the connector 521 and a waveguide path 124b of the substrate 101.

The millimeter wave signal output from a transmission chip 102b is inserted in the waveguide 201c via a waveguide path 124c of the substrate 101 and the waveguide path 571c of the connector 521.

The millimeter wave signal transmitted by the waveguide 201d is supplied to a reception chip 103b via the waveguide path 571d of the connector 521 and a waveguide path 124d of the substrate 101.

As described above, in the communication module 501a, the waveguides 201a to 201d may be individually arranged in the vertical direction and inserted in the connector 521. As a result, the communication module 501a may obtain an effect similar to that of the above-described communication module 21a. Furthermore, since it is not necessary to insert a conductive plate in the connector 521, it is also possible to make the connector 521 smaller than the connector 105 of the communication module 21a, and make the communication module 501a smaller than the communication module 21a.

Note that the communication module 501b has a configuration similar to that of the communication module 501a and the description thereof is not repeated.

### 5. Variation

A variation of the embodiments of the present technology described above is hereinafter described.

The number of stacked waveguides of the transmission cable described above is merely an example and may be arbitrarily changed.

Furthermore, although the example in which the side surface of the waveguide arranged in a position the closest to the substrate is brought into contact with the mounting surface of the substrate is described, it is also possible to prevent the same from coming into contact with the mounting surface of the substrate as is the case with other waveguides. Note that it is possible to lower a height of a connector by making the same to come into contact with the mounting surface of the substrate.

Moreover, in the above description, the example in which the waveguides are arranged in the direction perpendicular to the mounting surface of the substrate to be inserted in the connector is described, but the present technology is also applicable to a case in which the waveguides are arranged in a direction parallel to the mounting surface of the substrate to be inserted in the connector, for example. In other words, the present technology is also applicable to a case where the waveguides are arranged such that opposed surfaces of a plurality of waveguides are perpendicular to the mounting surface of the substrate.

Furthermore, the present technology is also applicable to a case where the insertion unit of the transmission cable is provided on a surface of the connector other than a surface perpendicular to the mounting surface of the substrate. For example, in a case where the insertion unit is provided on an upper surface of the connector, the waveguide is inserted in the connector perpendicularly to the mounting surface of the substrate, and a waveguide path corresponding to each waveguide in the connector may be arranged so as to extend in the direction perpendicular to the mounting surface of the substrate.

Moreover, in the above description, although the example in which the width of the conductive plate is larger than that of the waveguide is described, it is also possible to make the width of the conductive plate equal to or smaller than the width of the waveguide. In this case, for example, a slot is provided for each waveguide in the insertion unit of the connector.

Furthermore, for example, a member having conductivity other than the conductive rubber may be used to block a gap between the conductive plate and the connector. Moreover, it is also possible to make the conductive plate directly come into contact with the connector without providing the conductive rubber.

Furthermore, for example, it is also possible to prevent the conductive plate from protruding from a tip end of the waveguide. In this case, it is desirable to take measures to reduce the gap between the waveguide and the connector by a method other than the above-described conductive rubber.

Moreover, the number and positions of the conductor springs described above are merely examples and may be changed arbitrarily. Note that, as described above with reference to FIG. 13, as the width of the gap defined by the conductor spring becomes narrower, leakage of electromagnetic waves may be reduced.

Furthermore, in the above description, the example in which the waveguide and the conductive plate are pressed downward by the conductor spring is described, but it is also possible to press them upward. In this case, for example, the conductor spring is arranged on a floor surface of the slot of the insertion unit of the connector and the like.

Moreover, the conductor spring may also be provided on the waveguide and the conductive plate in place of the connector.

Furthermore, the waveguide and the conductive plate may also be fixed to the connector by a fixing member having conductivity other than the conductor spring.

Moreover, although the configuration in which the transmission cable or the waveguide may be detachably attached to the connector is described above, the present technology is also applicable to a case of fixing the transmission cable and the waveguide to the connector. In other words, even in a case where the transmission cable and the waveguide are not detachable but fixed to the connector, it is possible to reduce a size of the connector by arranging a plurality of waveguides such that wider side surfaces are opposed to each other to be inserted in the connector as described above.

Furthermore, for example, in a case where a cross-section of the waveguide is close to a square and there is not much difference between the widths of the side surfaces, it is also possible to arrange a plurality of waveguides such that a narrower side surfaces are opposed to each other to be inserted in the connector.

Moreover, in the present technology, the cross-section of the waveguide is not necessarily a perfect rectangle, and may be, for example, a substantially rectangular shape with rounded corners. Furthermore, it is also possible to make the cross-section of the waveguide a shape other than a rectangle.

Furthermore, although the example in which each chip of the communication module performs either transmission or reception is described above, it is also possible to use a chip that performs bidirectional communication. In this case, signals are transmitted bidirectionally in a waveguide and a waveguide path corresponding to the chip performing the bidirectional communication.

Moreover, although the example in which the chips are arranged on the substrate in either the insertion direction of the transmission cable or the direction perpendicular to the insertion direction is described above, it is also possible to arrange the chips in both directions.

Furthermore, although the example of transmitting the signal in the millimeter wave band is described above, the present technology is also applicable to a case of transmitting a signal in a frequency band other than the millimeter wave band as long as this is a signal which may be transmitted by the waveguide.

Note that the embodiment of the present technology is not limited to the embodiments described above, and various modifications may be made without departing from the gist of the present technology.

Furthermore, for example, the present technology may also take the following configurations.

(1)

A connector for a waveguide provided with:

an insertion unit in which a plurality of waveguides is inserted in a state in which side surfaces are opposed to each other; and

a plurality of waveguide paths which connects a mounting surface which is a surface mounted on a substrate and the insertion unit and transmits signals transmitted by corresponding waveguides.

(2)

The connector for a waveguide according to (1) described above, with the insertion unit to and from which the plurality of waveguides is able to be attached and detached, the connector further provided with:

a fixing member which directly or indirectly applies force in a direction in which the side surfaces of the waveguides oppose to each other to fix a waveguide to the insertion unit.

(3)

The connector for a waveguide according to (2) described above,

in which ends of opposed surfaces of adjacent waveguides are joined to opposite surfaces of a conductive plate, so that the plurality of waveguides is bundled, and

the fixing member includes a first fixing member having conductivity which pushes a side surface of the waveguide of at least one of the waveguides arranged on outermost sides in the direction in which the side surfaces of the waveguides oppose to each other.

(4)

The connector for a waveguide according to (3) described above,

in which the conductive plate is wider than a surface joined to the conductive plate of the waveguide,

the insertion unit is provided with a slot for inserting the conductive plate, and

the fixing member includes a second fixing member having conductivity which pushes the conductive plate in the direction in which the side surfaces of the waveguides oppose to each other in the slot.

(5)

The connector for a waveguide according to (4) described above, with the conductive plate protruding from a tip end of the waveguide, the connector further provided with:

a conductive rubber in a position where the tip end of the conductive plate abuts when the plurality of waveguides is inserted in the insertion unit.

(6)

The connector for a waveguide according to any one of (1) to (5) described above,

in which the insertion unit is formed on a surface perpendicular to the mounting surface, and

the plurality of the waveguides is inserted in the insertion unit so as to be arranged in a direction perpendicular to the mounting surface.

(7)

The connector for a waveguide according to (6) described above,

in which a mounting surface side of the insertion unit is opened, and

a side surface of the waveguide inserted in a position the closest to the mounting surface comes into contact with the substrate via the opening of the insertion unit.

(8)

The connector for a waveguide according to (6) or (7) described above,

in which openings on the mounting surface side of the plurality of waveguide paths are arranged in an insertion direction of the waveguide.

(9)

The connector for a waveguide according to any one of (1) to (8) described above,

in which a cross-section of the waveguide is substantially rectangular, and

the plurality of waveguides is inserted in the insertion unit in a state in which wider side surfaces of the waveguides are arranged so as to be opposed to each other.

(10)

A communication module provided with:

a substrate; and

a first connector for a waveguide mounted on a first surface of the substrate,

in which the first connector for a waveguide is provided with:

a first insertion unit in which a plurality of waveguides is inserted in a state in which side surfaces are opposed to each other; and

a plurality of first waveguide paths which connects a first mounting surface which is a surface mounted on the first surface of the substrate to the first insertion unit and transmits signals transmitted by corresponding waveguides.

(11)

The communication module according to (10) described above,

in which the substrate is provided with a plurality of second waveguide paths connected to the first waveguide paths, respectively, and

at least partial sections of the second waveguide paths are stacked in the substrate.

(12)

The communication module according to (11) described above, further provided with:

a plurality of chips each of which performs at least either transmission or reception of a signal through each of the waveguides,

in which the second waveguide paths connect corresponding chips to the first waveguide paths, respectively.

(13)

The communication module according to (12) described above,

in which the first insertion unit is formed on a surface perpendicular to the mounting surface, and

the chips are arranged on the substrate in at least one of an insertion direction of the waveguides in the first insertion unit or a direction perpendicular to the insertion direction.

(14)

The communication module according to (12) or (13) described above,

in which the chips are mounted on both sides of the substrate.

(15)

The communication module according to any one of (11) to (14) described above,

in which each of the second waveguide paths includes a conductor layer formed on a surface and inside of the substrate and a via connecting adjacent conductor layers.

(16)

The communication module according to any one of (11) to (15) described above, further provided with:

a second connector for a waveguide mounted on a second surface on a side opposite to the first surface of the substrate,

in which the second connector for a waveguide is provided with:

a second insertion unit in which the plurality of waveguides is inserted in a state in which side surfaces are opposed to each other; and

a plurality of third waveguide paths which connects a second mounting surface which is a surface mounted on the substrate to the second insertion unit and transmits signals transmitted by corresponding waveguides,

the substrate is provided with a plurality of fourth waveguide paths which connects to the third waveguide paths, and

at least partial sections of the second waveguide paths and the fourth waveguide paths are stacked in the substrate.

(17)

The communication module according to any one of (10) to (16) described above, further provided with:

a plurality of waveguides.

(18)

A transmission cable provided with:

a plurality of waveguides, and

a plurality of conductive plates,

in which side surfaces of the waveguides are arranged so as to be opposed to each other, and

ends of opposing surfaces of adjacent waveguides are joined to opposite surfaces of a conductive plate, so that the plurality of waveguides is bundled.

(19)

The transmission cable according to (18) described above,

in which the conductive plate is wider than a surface of a waveguide joined to the conductive plate, and

the conductive plate protrudes from a tip end of the waveguide.

(20)

An electronic device provided with:

a communication module provided with

a substrate; and

a connector for a waveguide mounted on the substrate; and

a signal processing unit which processes a signal transmitted through the communication module,

in which the connector for a waveguide is provided with:

an insertion unit in which a plurality of waveguides is inserted in a state in which side surfaces are opposed to each other; and

a plurality of waveguide paths which connects a mounting surface which is a surface mounted on the substrate to the insertion unit and transmits signals transmitted by corresponding waveguides.

### REFERENCE SIGNS LIST

10 Communication system
11a, 11b Electronic device
12 Transmission cable
21a, 21b Communication module
22a, 22b Signal processing unit
101 Substrate
102a, 102b Transmission chip
103a, 103b Reception chip
104a, 104b Shield
105, 106 Connector
121a to 121d Slot
122a to 122e Conductor layer
123a to 123d Via
124a to 124d Waveguide path
151 Main body portion
152L, 152R, 153aL to 153cR Conductor spring
154a to 154c Conductive rubber
161 Opening
162a to 162c Slot
163a to 163c Waveguide path
201a to 201d Waveguide
202a to 202c Conductive plate
301a, 301b Communication module
321 Substrate
322a, 322b Shield
341a to 341c Slot
342a to 342e Conductor layer
343a to 343d Via
344a to 344d Waveguide path
401a, 401b Transmission cable
402a, 402b Communication module
421 Substrate
422a, 422b Shield
423a, 423b Connector
441a to 441d Slot
442a to 442e Conductor layer
443a to 443d Via
444a to 444d Waveguide path
461a, 461b Main body portion
462aL to 462bR Conductor spring
463aL to conductor spring 463bR Conductor spring
464a, 464b Conductive rubber
471a, 471b Waveguide path
501a, 501b Communication module
521 Connector
561 Main body portion
562aL to 562dR Conductor spring
571a to 571d Waveguide path

1. A connector for a waveguide comprising:
an insertion unit in which a plurality of waveguides is inserted in a state in which side surfaces are opposed to each other; and
a plurality of waveguide paths which connects a mounting surface which is a surface mounted on a substrate and the insertion unit and transmits signals transmitted by corresponding waveguides.

2. The connector for a waveguide according to claim 1, with the insertion unit to and from which the plurality of waveguides is able to be attached and detached, the connector further comprising:
a fixing member which directly or indirectly applies force in a direction in which the side surfaces of the waveguides oppose to each other to fix a waveguide to the insertion unit.

3. The connector for a waveguide according to claim 2,
wherein ends of opposed surfaces of adjacent waveguides are joined to opposite surfaces of a conductive plate, so that the plurality of waveguides is bundled, and
the fixing member includes a first fixing member having conductivity which pushes a side surface of the waveguide of at least one of the waveguides arranged on outermost sides in the direction in which the side surfaces of the waveguides oppose to each other.

4. The connector for a waveguide according to claim 3,
wherein the conductive plate is wider than a surface joined to the conductive plate of the waveguide,
the insertion unit is provided with a slot for inserting the conductive plate, and
the fixing member includes a second fixing member having conductivity which pushes the conductive plate in the direction in which the side surfaces of the waveguides oppose to each other in the slot.

5. The connector for a waveguide according to claim 4, with the conductive plate protruding from a tip end of the waveguide, the connector further comprising:
a conductive rubber in a position where the tip end of the conductive plate abuts when the plurality of waveguides is inserted in the insertion unit.

6. The connector for a waveguide according to claim 1,
wherein the insertion unit is formed on a surface perpendicular to the mounting surface, and
the plurality of the waveguides is inserted in the insertion unit so as to be arranged in a direction perpendicular to the mounting surface.

7. The connector for a waveguide according to claim 6,
wherein a mounting surface side of the insertion unit is opened, and
a side surface of the waveguide inserted in a position the closest to the mounting surface comes into contact with the substrate via the opening of the insertion unit.

8. The connector for a waveguide according to claim 6,
wherein openings on the mounting surface side of the plurality of waveguide paths are arranged in an insertion direction of the waveguide.

9. The connector for a waveguide according to claim 1,
wherein a cross-section of the waveguide is substantially rectangular, and
the plurality of waveguides is inserted in the insertion unit in a state in which wider side surfaces of the waveguides are arranged so as to be opposed to each other.

10. A communication module comprising:
a substrate; and
a first connector for a waveguide mounted on a first surface of the substrate,
wherein the first connector for a waveguide is provided with:
a first insertion unit in which a plurality of waveguides is inserted in a state in which side surfaces are opposed to each other; and
a plurality of first waveguide paths which connects a first mounting surface which is a surface mounted on the first surface of the substrate to the first insertion unit and transmits signals transmitted by corresponding waveguides.

11. The communication module according to claim 10,
wherein the substrate is provided with a plurality of second waveguide paths connected to the first waveguide paths, respectively, and
at least partial sections of the second waveguide paths are stacked in the substrate.

12. The communication module according to claim 11, further comprising:
a plurality of chips each of which performs at least either transmission or reception of a signal through each of the waveguides,
wherein the second waveguide paths connect corresponding chips to the first waveguide paths, respectively.

13. The communication module according to claim 12,
wherein the first insertion unit is formed on a surface perpendicular to the mounting surface, and
the chips are arranged on the substrate in at least one of an insertion direction of the waveguides in the first insertion unit or a direction perpendicular to the insertion direction.

14. The communication module according to claim 12,
wherein the chips are mounted on both sides of the substrate.

15. The communication module according to claim 11,
wherein each of the second waveguide paths includes a conductor layer formed on a surface and inside of the substrate and a via connecting adjacent conductor layers.

16. The communication module according to claim 11, further comprising:
a second connector for a waveguide mounted on a second surface on a side opposite to the first surface of the substrate,
wherein the second connector for a waveguide is provided with:
a second insertion unit in which the plurality of waveguides is inserted in a state in which side surfaces are opposed to each other; and
a plurality of third waveguide paths which connects a second mounting surface which is a surface mounted on the substrate to the second insertion unit and transmits signals transmitted by corresponding waveguides,
the substrate is provided with a plurality of fourth waveguide paths which connects to the third waveguide paths, and
at least partial sections of the second waveguide paths and the fourth waveguide paths are stacked in the substrate.

17. The communication module according to claim 10, further comprising:
a plurality of waveguides.

18. A transmission cable comprising:
a plurality of waveguides, and
a plurality of conductive plates,
wherein side surfaces of the waveguides are arranged so as to be opposed to each other, and
ends of opposing surfaces of adjacent waveguides are joined to opposite surfaces of a conductive plate, so that the plurality of waveguides is bundled.

19. The transmission cable according to claim 18,
wherein the conductive plate is wider than a surface of a waveguide joined to the conductive plate, and
the conductive plate protrudes from a tip end of the waveguide.

20. An electronic device comprising:
a communication module provided with
a substrate; and
a connector for a waveguide mounted on the substrate; and
a signal processing unit which processes a signal transmitted through the communication module,
wherein the connector for a waveguide is provided with:
an insertion unit in which a plurality of waveguides is inserted in a state in which side surfaces are opposed to each other; and
a plurality of waveguide paths which connects a mounting surface which is a surface mounted on the substrate to the insertion unit and transmits signals transmitted by corresponding waveguides.
